(19) United States
(12) Patent Application Publication
(10) Pub. No.: US 2022/0041014 A1
(43) Pub. Date: Feb. 10, 2022

(54) TIRE, WHEEL AND VEHICLE

(71) Applicant: NINEBOT (CHANGZHOU) TECH CO., LTD., Changzhou (CN)

(72) Inventors: Weixiang WANG, Changzhou (CN); Xinjian JI, Changzhou (CN); Jun LUO, Changzhou (CN)

(21) Appl. No.: 17/393,547

(22) Filed: Aug. 4, 2021

(30) Foreign Application Priority Data
Aug. 5, 2020 (CN) 202010778773.8

(51) Int. Cl. B60C 5/02

(52) U.S. Cl. CPC B60C 5/02

(57) ABSTRACT

Embodiments of the present disclosure disclose a tire, a wheel and a vehicle, the tire includes an inner tube, a tire casing and a lubricating layer; the inner tube is a pneumatic tire, the tire casing is defined with an inner cavity, the inner tube is provided in the inner cavity, and the lubricating layer is provided between the inner tube and the tire casing. The lubricating layer is provided between two surfaces where the inner tube and the tire casing of the tire are in contact with each other, so as to reduce friction force caused by relative sliding between the inner tube and the tire casing slide when the tire pressure is zero or insufficient, avoid the inner tube from being worn out and then causing the air leakage, and improve the driving safety of the vehicle.

### CROSS-REFERENCE TO RELATED APPLICATION

This application is based on and claims priority to Chinese Patent Application No. 202010778773.8, filed on Aug. 5, 2020, the entire content of which is incorporated herein by reference.

### FIELD

Embodiments of the present disclosure belong to a technical field of vehicle equipment, and more particularly relates to a tire, a wheel and a vehicle.

### BACKGROUND

With regard to an existing tire with a pneumatic inner tube, an inner tube is fitted with a tire casing, in the case of zero or low tire pressure, the tire casing would be flattened where the tire casing is in contact with the ground, and the tire casing and the hub will slip when vehicle travels. Since a valve of the inner tube is fixed on the hub, the inner tube and the tire casing will slide relative to each other, and due to tight fitting and a relatively high friction between the inner tube and the tire casing, the inner tube is easy to be worn out and then results in air leakage.

### SUMMARY

In order to solve technical problems existing in a prior art, embodiments of the present disclosure provide a tire, a wheel and a vehicle.

In a first aspect, embodiments of the present disclosure provide a tire, and the tire includes an inner tube, a tire casing and a lubricating layer;

the inner tube being. a pneumatic tire, the tire casing being defined with an inner cavity, the inner tube being provided in the inner cavity, and the lubricating layer being provided between the inner tube and the tire casing.

In a second aspect, embodiments of the present disclosure provide a wheel, and the wheel includes the tire, and a hub;

the tire includes: an inner tube, a tire casing and a lubricating layer;

the inner tube is a pneumatic tire, the tire casing is defined with an inner cavity, the inner tube is provided in the inner cavity, and the lubricating layer is provided between the inner tube and the tire casing; and

the tire is mounted to a mounting groove of the hub.

In a third aspect, embodiments of the present disclosure provide a vehicle, and the vehicle includes the wheel, the wheel includes a tire and a hub, the tire includes an inner tube, a tire casing and a lubricating layer; the inner tube is a pneumatic tire, the tire casing is defined with an inner cavity, the inner tube is provided in the inner cavity, and the lubricating layer is provided between the inner tube and the tire casing; the tire is mounted to a mounting groove of the hub.

According to a technical solution provided by embodiments of the present disclosure, a lubricating layer is provided between the inner tube and the tire casing of the tire, so as to reduce friction force caused by relative sliding between the inner tube and the tire casing slide when the tire pressure is zero or insufficient, avoid the inner tube from being worn out and then causing the air leakage, and improve driving safety of the vehicle.

### BRIEF DESCRIPTION OF THE DRAWINGS

In order to describe the embodiments of the present disclosure or technical solutions in the prior art more clearly, the following will briefly introduce the accompanying drawings that need to be used in the description of the embodiments or the prior art. Obviously, the drawings in the following description are merely some embodiments of the present disclosure. For those skilled in the art, other drawings may be obtained based on these drawings without creative efforts.

FIG. 1 is a schematic cross-sectional view of a tire provided by an embodiment of the present disclosure;

FIG. 2 is an exploded perspective view of a tire provided by an embodiment of the present disclosure;

FIG. 3 is a schematic cross-sectional view A-A of FIG. 2;

FIG. 4 is a schematic cross-sectional view of an inner tube of a tire provided by an embodiment of the present disclosure;

FIG. 5 is a schematic cross-sectional view of a wheel provided by an embodiment of the present disclosure;

FIG. 6 is a schematic view of a vehicle according to an embodiment of the present disclosure.

### DETAILED DESCRIPTION

Implementations of the present disclosure will be described in detail below with reference to the accompanying drawings and embodiments, so as to fully understand and implement the realization process of how the present disclosure applies technical means to solve technical problems and achieve technical effects.

Some terms are used throughout the description and claims to refer to particular components. It should be understood by those skilled in the art that hardware manufacturers may refer to the same component in different terms. The description and claims do not intend to use differences in names as a way to distinguish components, but rather the differences in functions of the components as a criterion for distinction. For example, the term “include” mentioned throughout the description and the claims is used in an open-ended fashion, and thus should be interpreted as “include, but not limited to. “Substantially” refers to that, within an acceptable error range, those skilled in the art may solve the technical problem within a certain error range to substantially achieve the technical effect. In addition, the terms “coupled” or “electrically connected” herein encompass any direct or indirect electrical coupling means. Thus, if a first device is described to be coupled to a second device, it means that the first device may be directly electrically coupled to the second device, or indirectly electrically coupled to the second device via other devices or coupling means. The following specification is described as an embodiment of the present disclosure, and the description is for the purpose of illustrating the general principles of the present disclosure and is not intended to limit the scope of the present disclosure. The scope of the present disclosure should be determined with reference to the appended claims.

It should also be noted that the terms “comprises”, “comprising”, or any other variation thereof, are intended to cover a non-exclusive inclusion, such that a process, method, article, or system that comprises a list of elements does not include only those elements but may include other elements not expressly listed or inherent to such process, method, article, or system. Without further limitation, an element defined by the phrase “comprising a . . . ” does not exclude the presence of other identical elements in the process, method, article, or system in which the element is included.

### DETAILED DESCRIPTION OF THE DISCLOSURE

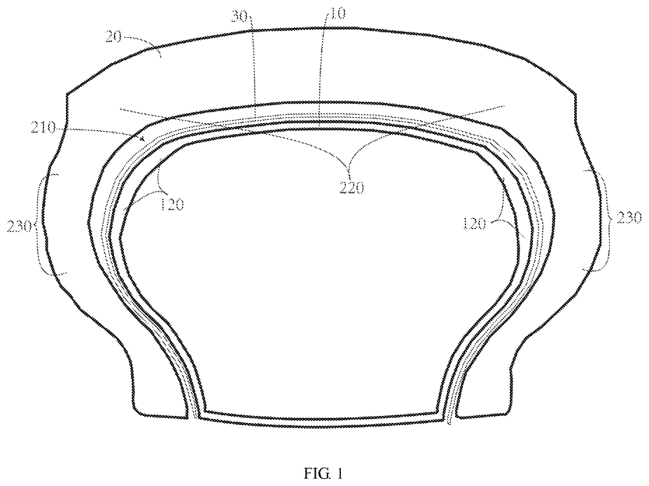

Referring to FIG. 1, a schematic cross-sectional view of a tire is provided for an embodiment of the present disclosure. The tire includes an inner tube 10, a tire casing 20, and a lubricating layer 30.

The inner tube 10 is a pneumatic tire, the tire casing 20 is defined with an inner cavity 210 in which the inner tube is provided, and the lubricating layer 30 is provided between the inner tube 10 and the tire casing 20.

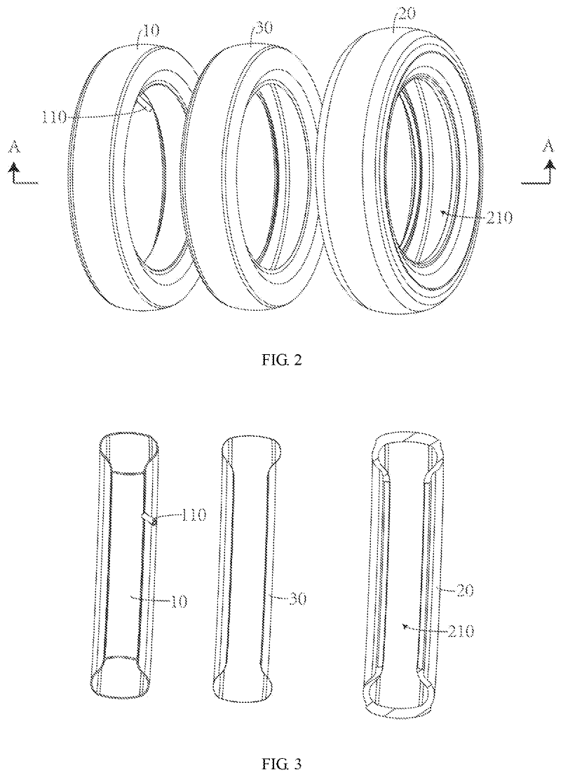

Specifically, referring to FIGS. 2 and 3, the inner tube 10 is in an annular closed structure and provided with a valve 110, the valve 110 is provided on a surface of the inner tube 10 and extends toward a center of an annular closed structure, and the inner tube 10 may be inflated through the valve 110. The material of the inner tube 10 includes but is not limited to, natural rubber, butyl rubber, etc., and the tire casing 20 is in a semi-closed annular structure, that is, a semi-closed inner cavity 210 is formed, and the inner tube 10 is put into the inner cavity 210 from an opening of the semi-closed annular structure, such that the tire casing 20 semi-wraps the inner tube 10 so as to protect the inner tube 10. Position of a part of the inner tube 10 corresponding to the opening of the semi-closed annular structure is not wrapped by the tire casing herein, and the valve 110 is provided at the position. The lubricating layer 30 is provided between the inner tube 10 and the tire casing 20. Specifically, the lubricating layer 30 is provided between an outer surface of the inner tube 10 and a surface of the inner cavity 210, the tire casing 20 completely wraps the lubricating layer 30, and the lubricating layer 30 covers a part of the outer surface of the inner tube 10, that is, the inner tube 10, the lubricating layer 30 and the tire casing 20 are laminated.

In use, if an air pressure of the inner tube 10 is around standard air pressure, a layered structure in tight contact is formed among the surface of the inner tube 10, the lubricating layer 30 and the tire casing 20 under tension of the inner tube 10, and the tire rotates normally on the road surface driven by a wheel hub. If the air pressure of the inner tube 10 is reduced to a certain extent or is zero, tension of the inner tube 10 is reduced or even disappears, the tire casing 20 is flattened by reaction force of the ground, and slip occurs between the tire casing 20 and the wheel hub when the wheel hub rotates. Since the inner tube 10 is fixed on the wheel hub by a valve 110, that is the inner tube 10 rotates along the wheel hub, and a relative slip inevitably occurs between the inner tube 10 and the tire casing 20. The tight fitting of the two and the reaction force of the ground against the tire casing 20 make friction force between the inner tube 10 and the tire casing 20 to be large, thereby causing the inner tube 10 easy to be worn out. However, in the embodiment of the present disclosure, the lubricating layer 30 is provided between the inner tube 10 and the tire casing 20, the friction force when the inner tube 10 and the tire casing 20 slide relative to each other may be effectively reduced by the lubricating layer 30, so as to avoid the inner tube 10 from being worn out and then causing the air leakage.

Furthermore, the lubricating layer 30 is formed by coating one of an oil, graphite, an emulsion, a grease and a release agent.

Specifically, the lubricating layer 30 is provided between the inner tube 10 and the tire casing 20 through a coating process, and the lubricating layer 30 is made of any one of, bat not limited to, an oil, graphite, an emulsion, a crease and a release agent, and those materials have good lubricating performance so as to effectively reduce the friction force when the inner tube 10 and the tire casing 20 slide relative to each other, and further reduce possibility that the inner tube 10 is worn out and leaks air.

In another embodiments of the present disclosure, the lubricant layer 30 is formed by spraying a release agent.

The release agent has good placing adhesion characteristics, that is, through the arrangement of the release agent the inner tube 10 and the tire casing 20 may be effectively separated, so as to effectively reduce the friction force when the inner tube 10 and the tire casing 20 slide relative to each other, and further reduce the possibility that the inner tube 10 is worn out and leaks air.

The release agent may be more uniformly distributed between the inner tube 10 and the tire casing 20 through a spraying process, such that a more uniform lubricating layer 30 is formed, and thus the lubricating performance of the lubricating layer 30 is further improved.

Furthermore, in a possible embodiment of the present disclosure, the lubricating layer 30 is provided on the outer surface of the inner tube 10.

Specifically, the lubricating layer 30 is provided on the outer surface of the inner tube 10 in contact with the inner cavity 210 by coating, spraying, or the like. It should be noted here that, in order to ensure a relative rest between the inner tube 10 and the wheel hub, the lubricating layer is generally not provided on the surface of the inner tube 10 in contact with the wheel hub, and that is, only part of the outer surface of the inner tube 10 is provided with the lubricating layer 30.

In addition, in another possible embodiment of the present disclosure, the lubricating layer 30 is provided on a surface of the inner cavity 210.

Herein, the lubricating layer 30 is provided on the tire casing 20 by coating, spraying or the like. Since the inner cavity 210 of the tire casing 20 is in full contact with the inner tube 10, that is the lubricating layer 30 is specifically provided on the surface of the inner cavity 210, as illustrated in the drawings, shape of the lubricating layer 30 is similar to shape of the inner cavity 210 of the tire casing 20.

Furthermore, if the air pressure of the inner tube 10 is less than standard vehicle air pressure, the tire casing 20 remains in its original shape.

Specifically, the standard vehicle air pressure herein refers to the air pressure of the inner tube 10 when the vehicle runs at normal load and normal speed. The tire casing 20 is made of a special material, such that the formed tire casing 20 has good supporting performance. Generally, when the air pressure of the inner tube 10 is less than the standard vehicle air pressure, tires of the vehicle may collapse. However, since the tire casing 20 of the embodiment of the present disclosure has good supporting performance, the tire casing 20 of the embodiment of the present disclosure may still keep its original shape, and volume of the inner tube 10 decreases with the reduction of the air pressure of the inner tube 10, such that a certain distance is formed between the inner tube 10 and the tire casing 20, thereby avoiding contact of the inner tube 10 and the tire casing 20, and accordingly avoiding the inner tube 10 from being damaged due to friction.

In addition, in another embodiments of the present disclosure, a cross section of the inner tube 10 is in a shape of a water droplet, and a thickness of each tire shoulder on both sides of the inner tube is greater than a thicknesses of any other part of the inner tube 10.

Specifically, when the tire stands on the ground, a width of one end of the inner tube 10 close to the ground is greater than a width of one end away from the ground, and the width of the inner tube 10 gradually decreases from one end close to the ground to one end away from the ground, such that the cross section of the inner tube 10 is in shape of a water droplet. The thickness of each two tire shoulders 120 of the inner tube 10 is designed to be greater than the thickness of any other part of the inner tube 10 to ensure that when the air pressure in the inner tube 10 is reduced, the part with large thickness firstly contracts, so as to further separate the part from the tire casing 120, and the inner tube 10 and the tire casing 20 do not rub against each other when the inner tube 10 and the tire casing 20 slide relative to each other, so as to further avoid the inner tube 10 from being worn out by the tire casing 20 and then causing the air leakage.

Furthermore, in one embodiment of the present disclosure, the thickness of each tire shoulder 120 on both sides of the inner tube 10 is 1.1 to 2 times the thickness of any other part of the inner tube 10.

Herein, a plurality of tests show that when the thickness of each tire shoulder 120 of the inner tube 10 is 1.1-2 times the thickness of any other part of the inner tube 10, overall elasticity of the inner tube 10 may be ensured, thus deformation and deviation do not occur when the air pressure meets driving requirements, and when the air pressure of the inner tube 10 is reduced, the tire shoulders 120 of the inner tube 10 contract firstly and then is separated from the tire casing 20, such that the tire shoulders 120 of the inner tube 10 and the tire casing 20 do not nib with each other when the tire shoulders 120 of the inner tube 10 and the tire casing 20 slide relative to each other. In an embodiment, the thickness of each tire shoulder 120 of the inner tube 10 is 1.2 times the thickness of any other part of the inner tube 10.

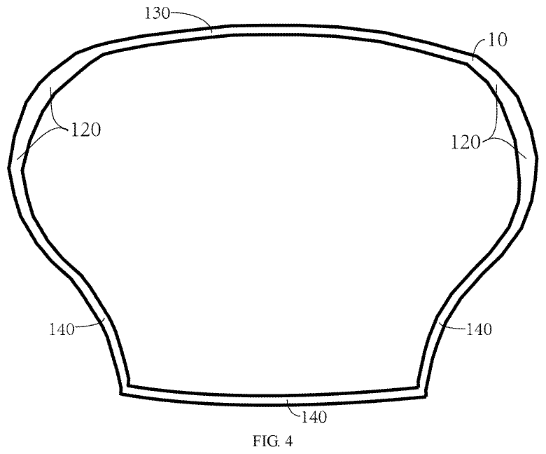

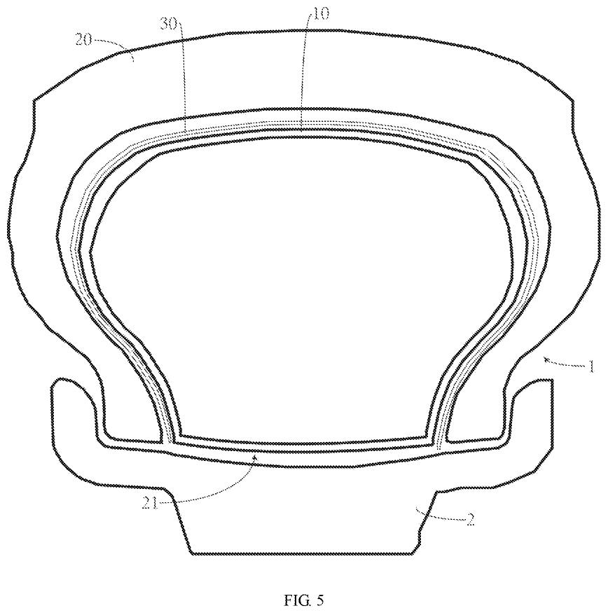

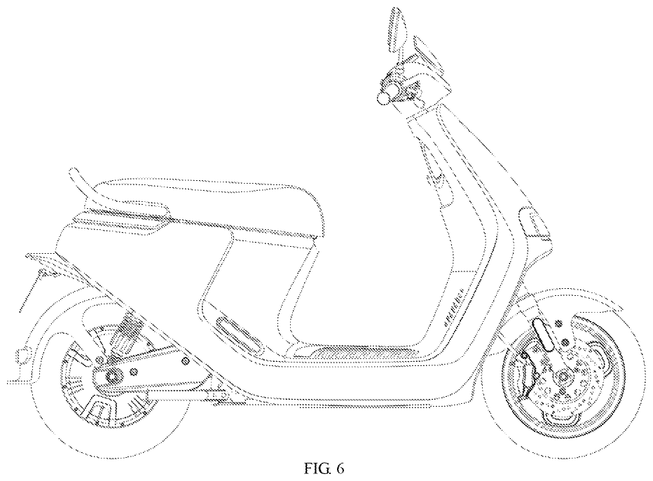

Furthermore, referring to FIG. 4, a schematic cross-sectional view of an inner tube of a tire is provided according to an embodiment of the present disclosure, upper portions of the two tire shoulders 120 are a contact portion 130 of the inner tube 10, and lower portions of the two tire shoulders 120 are a support portion 140 of the inner tube 10, and a length of the support portion 140 is greater than a length of the contact portion 130, and a width of the support portion 140 gradually decreases from the two tire shoulders 120 to an inner side of the inner tube 10.

Specifically, the contact portion 130 is an upper part of the tire shoulder 120, and is in contact with a tire crown of the tire casing 20 when the inner tube 10 is in an inflated state. The support portion 140 is a lower portion of the tire shoulder 120 and plays a supporting role when the inner tube 10 is in the inflated state. A length of the support portion 140 is longer than that of the contact portion 130, such that the support portion 140 has a relatively high height in the cross section of the inner tube 10, and in the cross section of the inner tube 10, the width of the support portion 140 gradually decreases from the two tire shoulders 120 to the inner side of the inner tube 10, such that the cross section of the inner tube 10 is made to be large at top and small at bottom, such as an inverted water droplet. The inner tube 10 designed in such a shape has a relatively good supportability when the inner tube 10 is in the inflated state, and when the air pressure of the inner tube 10 is reduced, the tire shoulder 120 of the inner tube 10 contracts firstly and then is separated from the tire casing 20, thereby further avoiding the inner tube 10 from being damaged due to friction.

In addition, in another embodiment of the present disclosure, at least 4 layers of cord fabric are provided in the tire crown 220 of the tire casing 20.

Additionally, at least 6 layers of the cord fabric are provided in two tire sides 230 of the tire casing 20, respectively.

Furthermore, specification of the cord fabric should not be less than 1260D/2. The cord fabric is woven from yarn, and the selected yarn is two yarns with a weight of not less than 1260 grams per 9000 meters to be twisted together to weave the cord fabric. The woven cord fabric has good toughness and strength.

Specifically, please refer to Tables 1 and 2 below.

Table 1 shows a comparison between a column pressure strength test and the outer tire test in a prior art, in which the column pressure strength test is performed when 4 layers of the cord fabric are provided in the tire crown 220, 6 layers of the cord fabric are provided in the tire side 230 and the specification of the cord fabric is 1260D/2.

TABLE 1

| | Comparative | |
|---|---|---|
| | Examples | Embodiment |
| Specifications of cord fabric | 630D/2 | 1260D/2 |
| Number of layers of cord fabric in tire crown | 2 | 4 |
| Number of layers of cord fabric in tire side | 4 | 6 |
| Column pressure strength (J) | 35.6 | 87.2 |

Table 2 shows a comparison between a rigid displacement value test and a test in the prior art, in which the rigid displacement value test is preformed when the air pressure of the inner tribe 10 is 50 psi, 30 psi and 0 psi, using a needle with a column rod diameter of 8 mm, a head speed of 50 mm/min, and a load of 600 N:

TABLE 2

| | Prior art | | | This Example | | |
|---|---|---|---|---|---|---|
| Air pressure (psi) | 50 | 30 | 0 | 50 | 30 | 0 |
| Load (N) | 600 | | | | | |
| Rigid displacement | 7.21 | 10.77 | 13.21 | 5.34 | 7.13 | 8.19 |
| value (mm) | | | | | | |

As illustrated in Table 1, by increasing the number of layers of the cord fabric in the tire crown 220 and the number of layers of cord fabric in tire side 230 of the tire casing, and increasing the specification of the cord fabric, the column pressure strength of the tire casing 20 may be improved, ant that is the supportability of the tire casing 20 may be effectively increased, so as to ensure that the tire casing 20 does not collapse when the air pressure of the inner tube 10 decreases or even becomes zero and the tire casing 20 does not contact the tire casing 20 after the inner tube 10 contracts, thereby avoiding the inner tube 10 from being worn out by the friction when the inner tube 10 and the tire casing 20 slide relative to each other. Moreover, by improving the column pressure strength of the tire casing 20, risk of the tire being punctured may be effectively reduced, and driving safety of the vehicle is further improved.

Table 2 shows a rigidity test of the tire with an instron tensile machine under a certain load. As illustrated in the table, with the same applied load, a rigidity displacement value of the tire in the embodiment of the present disclosure at a plurality of air pressure values (50 psi, 30 psi and 0 psi) is less than that of the tire in the prior art, which again proves that the tire of the embodiment of the present disclosure has better rigidity performance, such that the driving experience and the driving safety of the vehicle may be further improved.

Referring to FIG. 5, a schematic cross-sectional view of a wheel according to an embodiment of the present disclosure is provided, and the wheel includes a tire 1 and a hub 2.

The tire 1 includes an inner tube 10, a tire casing 20, and a lubricating layer 30, the tire 1 is any one of the tires in the above embodiments, and for the specific structure thereof, reference is made to the description of the above embodiments, which will not be described in detail herein.

The hub 2 is defined with a mounting groove 21, the tire 1 is mounted on the mounting groove 21 of the hub 2, other configurations of the wheel and associated connection relationships being known to those skilled in the art, and to which the embodiment of the present disclosure will not be described.

In addition, an embodiment of the present disclosure also provides a vehicle including the wheels mentioned in the above embodiments, through which the vehicle may be driven on the ground, with reference to the above description of the embodiments, other configurations of the vehicle, and related connection relationships, which are known to those skilled in the art, and to which the embodiment of the present disclosure will not be described.

It should be noted that although embodiments of the present disclosure have been described in detail with reference to the accompanying drawings, those embodiments should not be construed as a limitation to the protection scope of the present disclosure. In the case of non-contradiction of the structures, those structures of the parts mentioned in the above-mentioned embodiments may be combined with each other, and in order to avoid repetition, the technical solutions obtained by the combination are not described in detail herein, also fallen into the scope of the present disclosure. Within the scope described in the claims, various modifications and variations made those skilled in the art without any creative effort are fallen into the scope of the present disclosure.

Examples of the embodiments of the present disclosure are intended to concisely illustrate the technical features of the embodiments of the present disclosure such that those skilled in the art may intuitively understand the technical features of the embodiments of the present disclosure, which is not an improper limitation to the embodiments of the present disclosure.

The device embodiments described above are merely schematic, the components illustrated as separate components may or may not be physically separated, and the components displayed as display units may or may not be physical units, that is, they may be located in one place, or distributed over a plurality of network units. Some or all of the modules may be selected according to practical requirements to achieve the purpose of the solution of the embodiment, and those skilled in the art would understand and implement the solution without paying creative effort.

The above description shows and describes several preferred embodiments of the present disclosure, but as mentioned above, it should be understood that the embodiments are not limited to the forms disclosed herein, and should not be considered as excluding other embodiments, but can be used in various other combinations, modifications, and environments and can be changed within the scope of the inventive concept described herein according to above teachings or technologies or knowledge in related art. The modifications and variations made by those skilled in the art should be within the scope of the appended claims without departing from the spirit and scope of the embodiments of the present disclosure.

1. A tire comprising an inner tube, a tire casing and a lubricating layer;
the inner tube being a pneumatic tire, the tire casing being defined with an inner cavity, the inner tube being provided in the inner cavity, and the lubricating layer being provided between the inner tube and the tire casing.

2. The tire according to claim 1, wherein the lubricating layer is formed by coating one of an oil, graphite, an emulsion, a grease and a release agent.

3. The tire according to claim 1, wherein the lubricating layer is formed by spraying a release agent.

4. The tire according to claim 1, wherein the tire casing remains in its original shape if an air pressure of the inner tube is less than standard vehicle air pressure.

5. The tire according to claim 1 wherein a cross section of the inner tube is in a shape of a water droplet, and a thickness of each tire shoulder on both sides of the inner tube is greater than a thickness of any other part of the inner tube.

6. The tire according to claim 5, wherein upper portions of the two tire shoulders are a contact portion of the inner tube, lower portions of the two tire shoulders are a support portion of the inner tube, a length of the support portion is greater than a length of the contact portion, and a width of the support portion gradually decreases from the two tire shoulders to an inner side of the inner tube.

7. The tire according to claim 5, wherein the thickness of each tire shoulder on both sides of the inner tube is 1.1 to 2 times the thickness of any other part of the inner tube.

8. The tire according to claim 7, wherein the thickness of each tire shoulder on both sides of the inner tube is 1.2 times the thickness of any other part of the inner tube.

9. The tire according to claim 1, wherein at least 4 layers of cord fabric are provided in a tire crown of the tire casing.

10. The tire according to claim 1, wherein at least 6 layers of cord fabric are provided in two tire sides of the tire casing, respectively.

11. The tire according to claim 1, wherein the inner tube is in an annular closed structure and provided with a valve, the valve is provided on a surface of the inner tube and extends toward a center of the annular closed structure, and the inner tube is capable of being inflated through the valve.

12. The tire according to claim 1, wherein the material of the inner tube is any one of natural rubber, butyl rubber.

13. The tire according to claim 11, wherein the tire casing is in a semi-closed annular structure.

14. The tire according to claim 1, wherein the lubricating layer is provided on an outer surface of the inner tube.

15. The tire according to claim 1, wherein the lubricating layer is provided on a surface of the inner cavity.

16. The tire according to claim 9, wherein specification of the cord fabric is less than 1260D/2, and the cord fabric is woven from yarn.

17. The tire according to claim 9, wherein shape of the lubricating layer is similar to shape of the inner cavity of the tire casing.

18. A wheel, comprising:
a tire, wherein the tire comprises:
an inner tube, a tire casing and a lubricating layer;
wherein the inner tube is a pneumatic tire, the tire casing is defined with an inner cavity, the inner tube is provided in the inner cavity, and the lubricating layer is provided between the inner tube and the tire casing; and
a hub, the tire being mounted to a mounting groove of the hub.

19. The wheel according to claim 18,wherein a cross section of the inner tube is in a shape of a water droplet, and a thickness of each tire shoulder on both sides of the inner tube is greater than a thickness of any other part of the inner tube.

20. A vehicle, comprising a wheel,
wherein the wheel comprises:
a tire, wherein the tire comprises:
an inner tube, a tire casing and a lubricating layer;
wherein the inner tube is a pneumatic tire, the tire casing is defined with an inner cavity, the inner tube is provided in the inner cavity, and the lubricating layer is provided between the inner tube and the tire casing; and
a hub, the tire being mounted to a mounting groove of the hub.
